(19) United States
(12) Patent Application Publication
(10) Pub. No.: US 2026/0211237 A1
(43) Pub. Date: Jul. 23, 2026

(54) TRANSMISSIVE GRATING-BASED SCANNER FOR SMALL WAVEGUIDE COUPLING WALK-OFF

(71) Applicant: Meta Platforms Technologies, LLC, Menlo Park, CA (US)

(72) Inventors: Youmin WANG, Bellevue, WA (US); Min Chul SHIN, Bellevue, WA (US); Ehsan VADIEE, Bothell, WA (US)

(73) Assignee: Meta Platforms Technologies, LLC, Menlo Park, CA (US)

(21) Appl. No.: 19/033,277

(22) Filed: Jan. 21, 2025

(51) Int. Cl. G02B 27/01; G02B 26/08

(52) U.S. Cl. CPC G02B 27/0172; G02B 26/0808

(57) ABSTRACT

Design and fabrication of a micro rotary scanning element for waveguide based display in wearable augmented reality/virtual reality (AR/VR) devices is disclosed. In examples, a micro rotary scanning element for an augmented reality/virtual reality (AR/VR) display device, the micro rotary scanning element, comprising a transmissive grating structure, and an angular comb drive structure, wherein the transmissive grating structure is to diffract received collimated light and is anchored to the angular comb drive structure, and the angular comb drive structure comprises a plurality of inter-positioned comb elements to provide angular rotation to the transmissive grating structure.

### PRIORITY

The present application claims priority to U.S. provisional patent application Ser. No. 63/549,248, filed on Feb. 2, 2024, which is incorporated by reference in its entirety.

### TECHNICAL FIELD

This patent application relates generally to augmented and/or virtual reality (AR/VR) near-eye display devices, and in particular, to design and fabrication of a micro rotary scanning element for waveguide based display in wearable augmented reality/virtual reality (AR/VR) devices.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment. Head-mounted display (HMD) devices may also present interactive content, where a user's (wearer's) gaze may be used as input for the interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIGS. 2A-2C illustrate various views of a near-eye display device in the form of a head-mounted display (HMD) device, according to examples.

FIG. 3 illustrates a perspective view of a near-eye display in the form of a pair of glasses, according to an example.

FIG. 4 illustrates major components of a waveguide display system and a waveguide eye tracking system, according to examples.

FIG. 5 illustrates schematically waveguide coupled eye tracking, according to examples.

FIG. 6 illustrates schematically 1D+1D scanning based waveguide coupling, according to an example.

FIGS. 7A-7B illustrate the walk-off effect for the input coupler for projectors, according to examples.

FIG. 8 illustrates an example operation of laser beam scanning using a transmissive rotary scanning grating, according to an example.

FIG. 9 illustrates a micro rotary transmissive grating element actuated by MEMS rotary actuators, according to an example.

FIG. 10 illustrates a fabrication flow of an example micro rotary scanning grating device, according to examples.

FIG. 11 illustrates a flow diagram for a method of fabricating a micro rotary scanning grating device, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Scanning displays are an important category of projectors in AR/VR display devices. A laser beam generated by the scanning display couples into an input coupling grating and is further relayed by the eye tracking waveguide eventually out-coupling toward the eye. Scanning based projectors suffer from relatively large walk-off after the reflection of the second reflective scanning mirror. Walk-off effect is described as a path followed by an o-beam that coincides with kp, while a path followed by an e-beam does not. The walk-off distance may be determined from the walk-off angle θ as δ=Ltanθ, where L is the length of the medium.

In some examples of the present disclosure, design and fabrication of a micro rotary scanning element is described. The micro rotary scanning element is transmissive and therefore can reduce the distance between the scanning element and the input coupling grating of a waveguide. A linear transmissive grating may be rotated, allowing scanning of diffractive orders of the transmitted light according to the k-vector change of the grating structure.

While some advantages and benefits of the present disclosure are apparent, other advantages and benefits may include reduction of walk-off effect and miniaturization of transmissive grating design allowing in-field implementations.

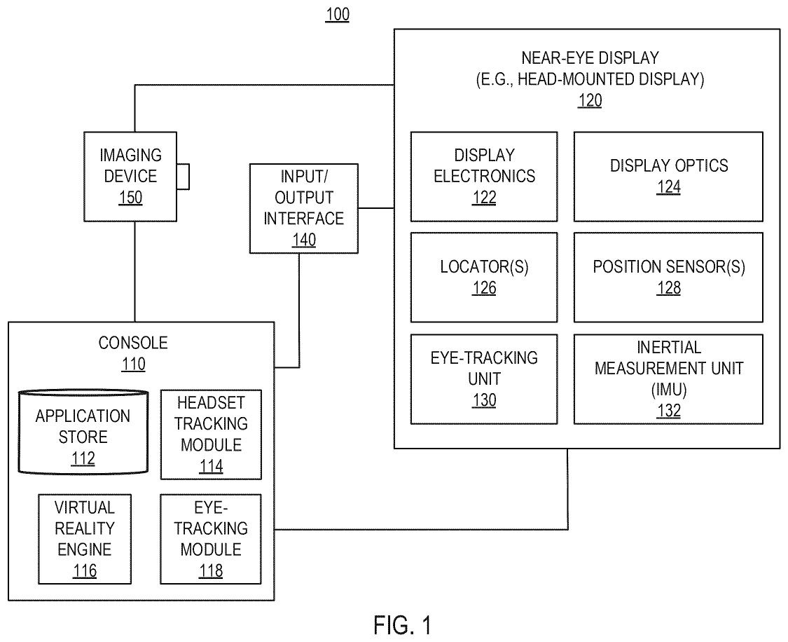

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

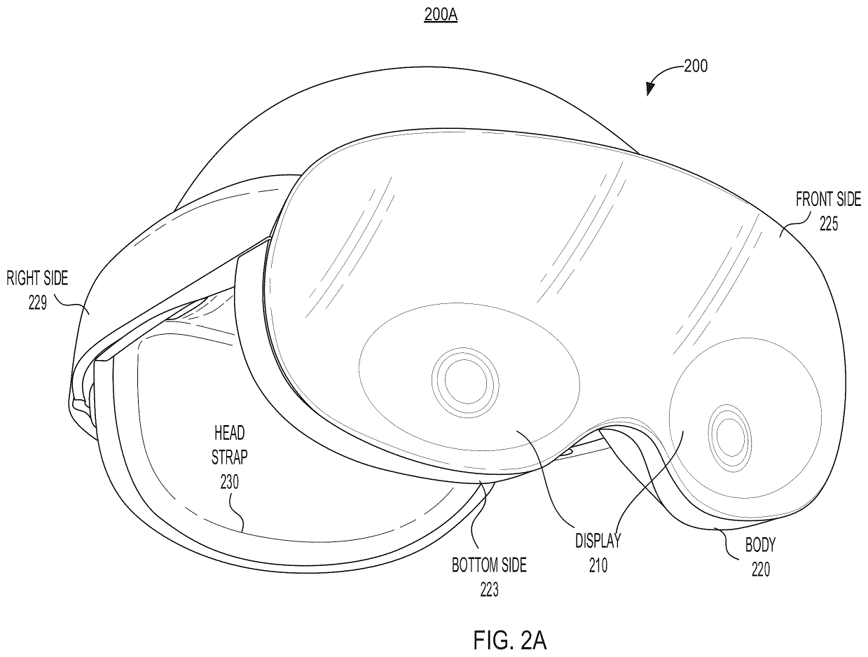

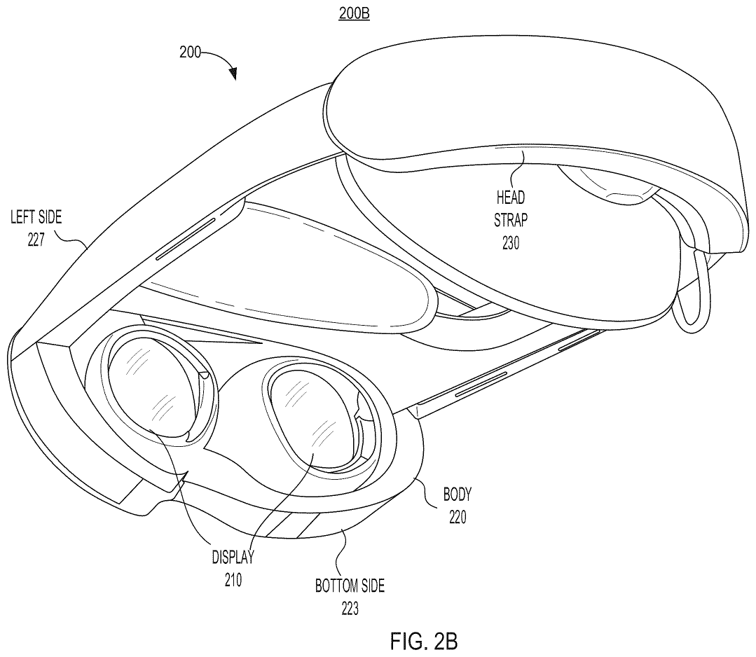

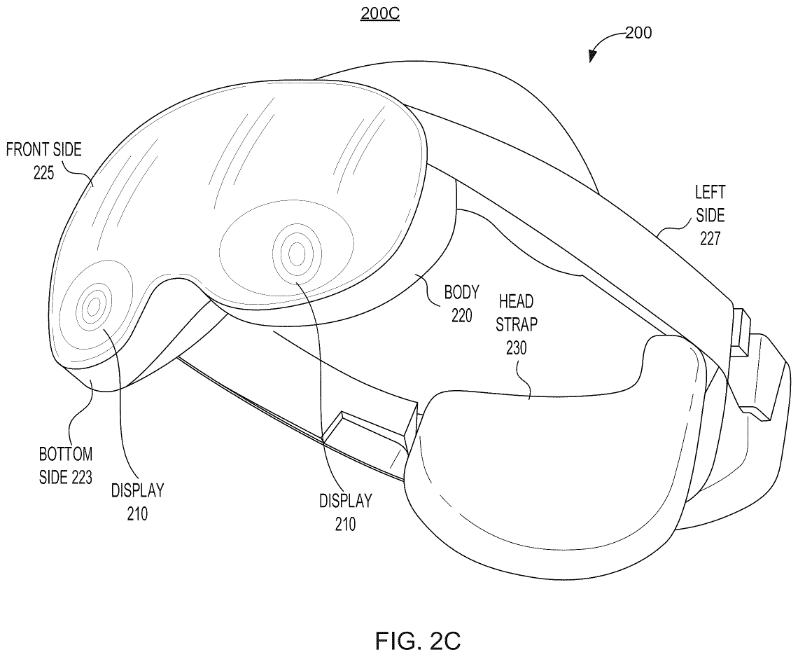

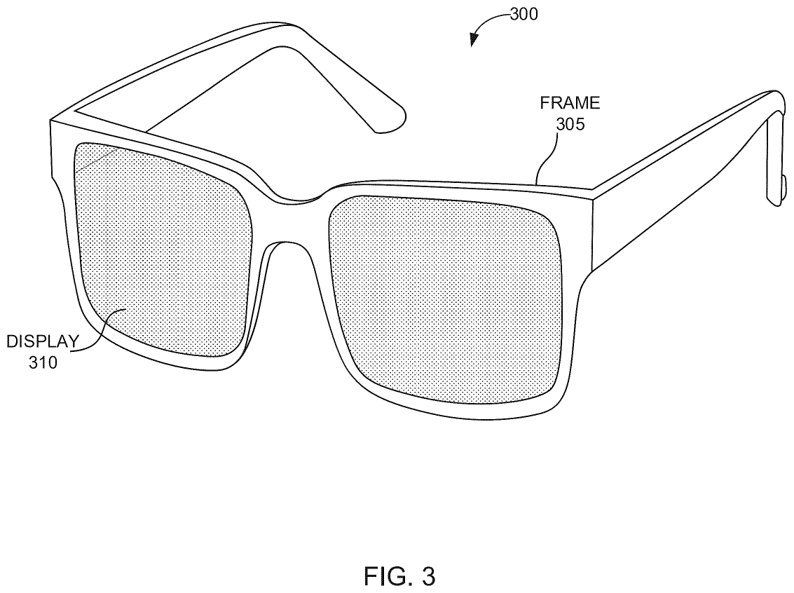

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube deflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera).

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

As mentioned herein, a transmissive micro rotary scanning element may be designed and fabricated to reduce a distance between the scanning element and the input coupling grating of the waveguide. The linear transmissive grating may be rotated, allowing scanning of diffractive orders of the transmitted light according to the k-vector change of the grating structure.

FIGS. 2A-2C illustrate various views of a near-eye display device in the form of a head-mounted display (HMD) device 200, according to examples. In some examples, the head-mounted device (HMD) device 200 may be a part of a virtual reality (VR) system, an augmented reality (AR) system, a mixed reality (MR) system, another system that uses displays or wearables, or any combination thereof. As shown in diagram 200A of FIG. 2A, the head-mounted display (HMD) device 200 may include a body 220 and a head strap 230. The front perspective view of the head-mounted display (HMD) device 200 further shows a bottom side 223, a front side 225, and a right side 229 of the body 220. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components such as a display 210 to present a wearer augmented reality (AR)/virtual reality (VR) content and a camera to capture images or videos of the wearer's environment.

As shown in the bottom perspective view of diagram 200B of FIG. 2B, the display 210 may include one or more display assemblies and present, to a user (wearer), media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the user may interact with the presented images or videos through eye tracking sensors enclosed in the body 220 of the head-mounted display (HMD) device 200. The eye tracking sensors may also be used to adjust and improve quality of the presented content.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface for communicating with a console communicatively coupled to the head-mounted display (HMD) device 200 through wired or wireless means. In some examples, the head-mounted display (HMD) device 200 may include a virtual reality engine (not shown) that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine may be used for producing a signal (e.g., display instructions) to the display 210. In some examples, the head-mounted display (HMD) device 200 may include locators (not shown), which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped like eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

FIG. 3 is a perspective view of a near-eye display 300 in the form of a pair of glasses (or other similar eyewear), according to an example. In some examples, the near-eye display 300 may be a specific example of near-eye display 120 of FIG. 1 and may be configured to operate as a virtual reality display, an augmented reality (AR) display, and/or a mixed reality (MR) display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1 and 2A-2C. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 310 may include a projector, or in place of the display 310 the near-eye display 300 may include a projector.

In some examples, the near-eye display 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors may also be used for stereoscopic imaging or other similar applications.

In some examples, a micro rotary scanning element that is transmissive and therefore can reduce the distance between the scanning element and the input coupling grating of the waveguide is provided. The linear transmissive grating may be rotated allowing scanning of diffractive orders of the transmitted light according to the k-vector change of the grating structure.

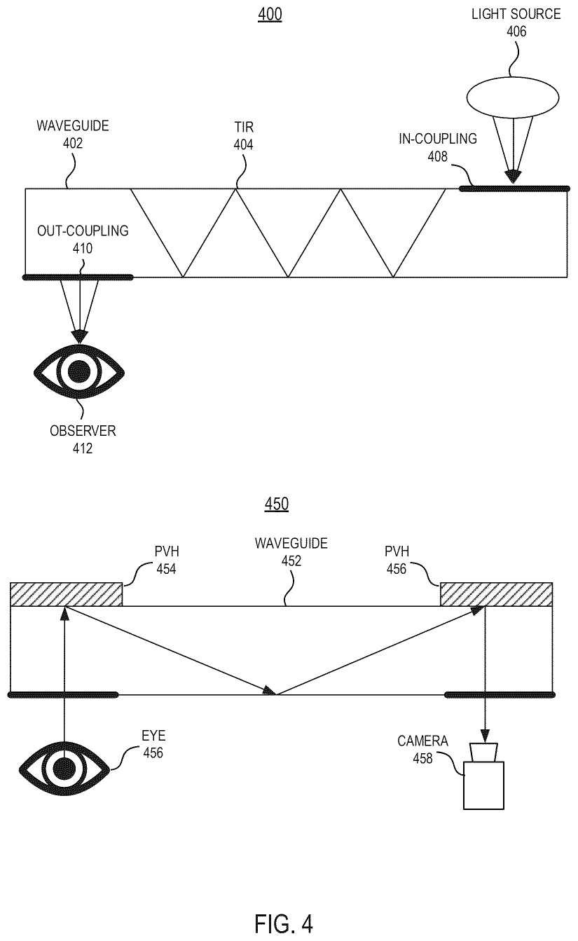

FIG. 4 illustrates major components of a waveguide display system and a waveguide eye tracking system, according to examples. As shown in diagram 400 in FIG. 4, in a waveguide architecture, light from a light source 406 (e.g., a collimated light source) may be coupled in to a waveguide 402 through an in-coupling element 408. The light may propagate inside the waveguide 402 through total internal reflection (TIR) 404 and couple out through an out-coupling element 410 focused onto an eye (observer) 412. The in-coupling element 408 may provide an angle to light to ensure TIR within the waveguide 402. The out-coupling element 410 may focus the outgoing light onto the eye 412.

Diagram 450 in FIG. 4 shows a waveguide architecture with polarization volume hologram (PVH) reflection. In the example configuration, light from the eye 456 may couple in to the waveguide 452 and be reflected by a first PVH element 454 into the waveguide. Internally reflected light may be reflected out of the waveguide 452 by a second PVH element 456 into an eye tracking camera 458. The configurations in diagram 400 and 450 are example configurations for illustration purposes. Examples of this disclosure may be implemented using other elements and configurations of a waveguide-based architecture.

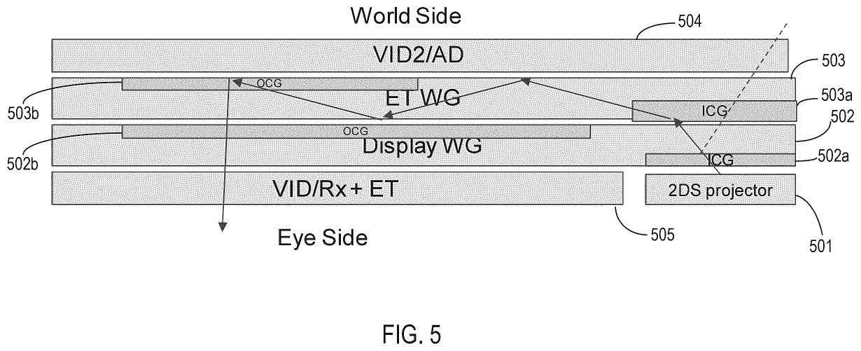

FIG. 5 illustrates schematically waveguide coupled eye tracking, according to examples. Diagram 500 shows a two-dimensional (2D) projector 501 providing light into a display waveguide (WG) 502 through an input coupling grating (ICG) 502a. The display waveguide 502 also includes an output coupling grating (OCG) 502b and is stacked with an eye tracking waveguide 503 with its own ICG 503a and OCG 503b. On the world-side of the stack, there is a second virtual imaging distance (VID) lens 504. On the eye-side of the display waveguide, a first VID lens, an optional prescription lens, and eye tracking electronics 505 may be placed.

In a surrounding perception system for AR/VR systems, such as eye tracking, heading tracking, gesture tracking, and surrounding obstacle detection, it is usually desired to have waveguide coupling. Scanning displays are an important category of projectors in AR/VR display devices. A laser beam generated by the scanning display couples into an input coupling grating and is further relayed by the eye tracking waveguide eventually out-coupling toward the eye. Scanning based projectors suffer from relatively large walk-off after the reflection of the second reflective scanning mirror. Walk-off effect is described as a path followed by an (ordinary) o-beam that coincides with kp, while a path followed by an (extra-ordinary) e-beam does not. The walk-off distance may be determined from the walk-off angle θ as δ=Ltanθ, where L is the length of the medium.

As shown in diagram 500, scanning display is an important category of projectors. The laser beam generated from scanning display couples into the input coupling grating (ICG) 502a/503a, and further relayed by the eye tracking waveguide 503, then eventually out coupled toward the eye.

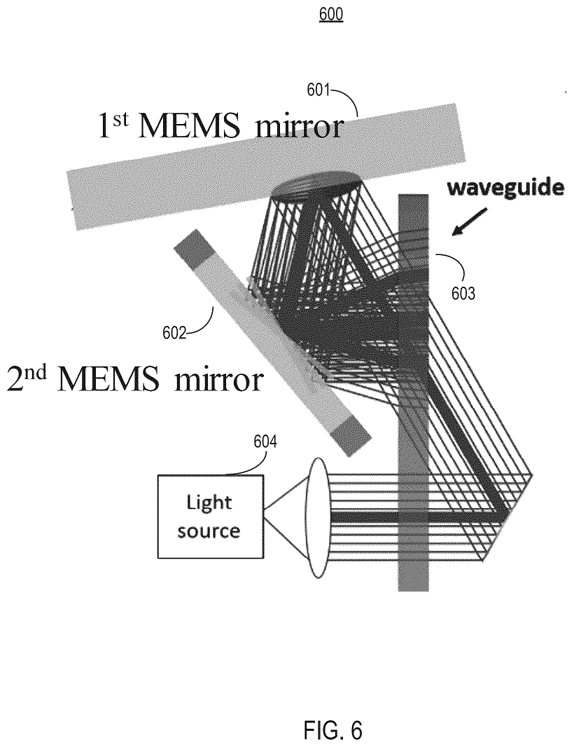

FIG. 6 illustrates schematically 1D+1D scanning based waveguide coupling, according to an example. Diagram 600 shows two micro-electromechanical system (MEMS) mirrors 601, 602 operating together with a waveguide 603 and a light source 604 as a 2D scanning projector.

The configuration in diagram 600 demonstrates a 1D plus 1D scanning architecture, which is a close up view of the 2D projector in FIG. 5. Conventional scanning-based projectors tend to have relatively large walk-off after the reflection of the second reflective scanning mirror. One of the major challenges with 2×1D projector is the pupil walk-off between the two MEMS, since the light footprints from the first MEMS spread out along the first MEMS scanning dimension when the light exits the first MEMS and propagates to the second MEMS. As shown in diagram 600, the reflective second MEMS mirror 602 introduces significant obliquity and additional distance between the MEMS mirror 602 and the input coupler within the waveguide 603.

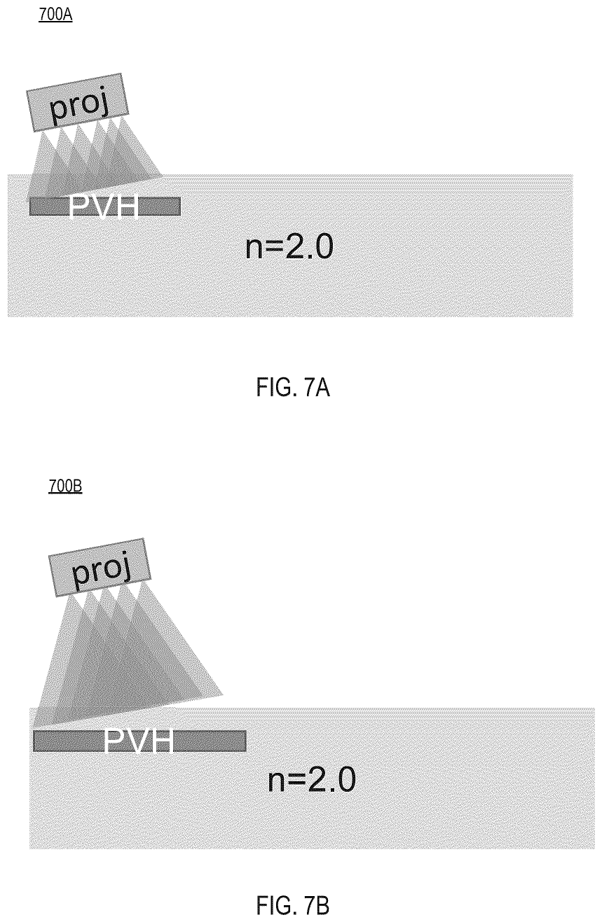

FIGS. 7A and 7B illustrate the walk-off effect for the input coupler for projectors, according to examples. Diagrams 700A and 700B show short and long walk-off effect illustrations. Since the laser beam is scanning by the scanners, this additional distance will cause additional walk-off on the input couplers, as shown in FIG. 3. This walk-off will bring some significant draw backs to the sensing system: A larger walk-off requires larger in-coupler and without appropriate spatial patterning, in-coupler losses may increase.

To mitigate walk-off effect, one approach is to adopt a pupil relay in between two MEMS, so that the pupil on first MEMS can be relayed to the second MEMS. However, a pupil relay normally occupies large volume which makes the form factor impractical. An alternative approach may be to remove any optical elements between the two MEMS, use a rectangular slow MEMS as the second MEMS, and minimize the optical path between the two MEMS to avoid larger pupil walk-off. However, this approach may complicate the optical elements and MEMS design.

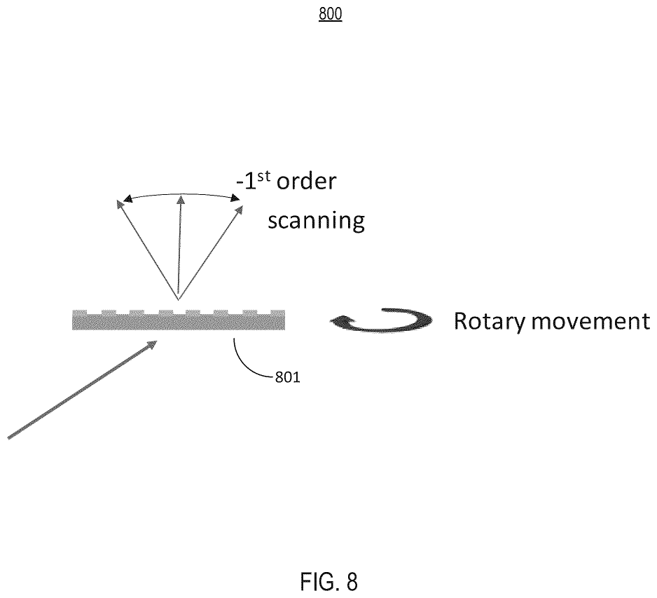

FIG. 8 illustrates an example operation of laser beam scanning using a transmissive rotary scanning grating, according to an example. Diagram 800 shows a transmissive rotary scanning grating 801 receiving collimated light and spreading it to 1^{st} order scanning through a rotary movement. In some examples, design and fabrication of a micro rotary scanning element that is transmissive and therefore can reduce the distance between the scanning element and the input coupling grating of the waveguide is provided.

The micro rotary scanning element is compatible with solid-state semiconductor fabrication. As shown in diagram 800, through the rotation of the linear transmissive grating, the diffractive orders of the transmitted light may scan according to the k-vector change of the grating structure. The grating design may be optimized to increase the light efficiency of specific orders of the transmission.

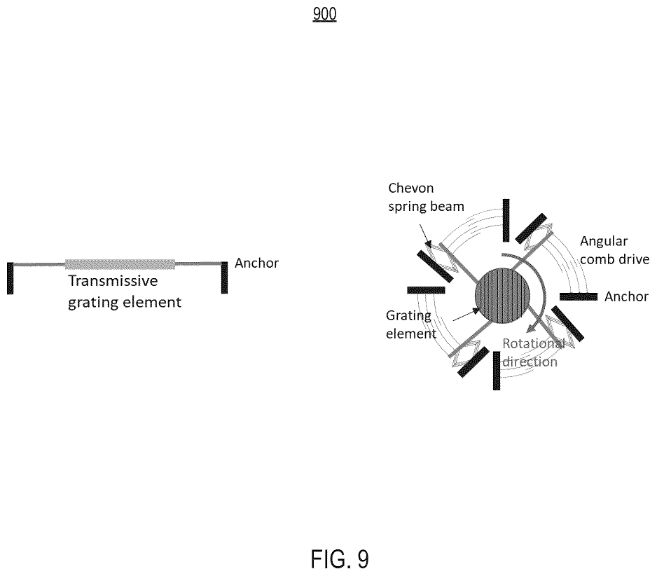

FIG. 9 illustrates a micro rotary transmissive grating element actuated by MEMS rotary actuators, according to an example. Diagram 900 shows the integrated transmissive grating element with its anchors and in rotation actuated by MEMS rotary actuators. In some examples, the transmissive grating element may be miniaturized onto semiconductor device level, as discussed herein. In other examples, two SOIs may be used to fabricate a micro polygon, enabling the mass production of the polygon on wafer level.

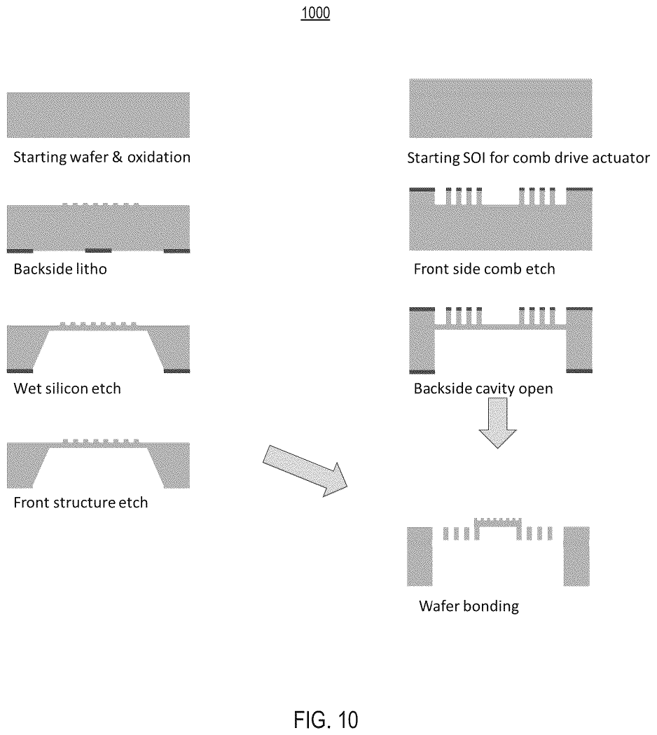

FIG. 10 illustrates a fabrication flow of an example micro rotary scanning grating device, according to examples. Diagram 1000 shows various fabrication steps and associated cross-sectional views of the micro rotary scanning element. As shown in diagram 1000, two wafers may be needed to complete the fabrication process. The first wafer may pass through the wet wafer etching at the handle layer to achieve the grating structure on top. Front side etching may be used to form the grating structure. A second SOI wafer may be used to form the angular comb drive actuator in its device layer. Subsequently, the two wafers may be bonded together and released to have rotational degree of freedom.

Thus, the fabrication steps may include wafer oxidation, backside lithography, wet silicon etch, and front structure etch for the first wafer. The steps may include front side comb etch (for the comb drive actuator) and backside cavity opening. The two wafers may then be bonded.

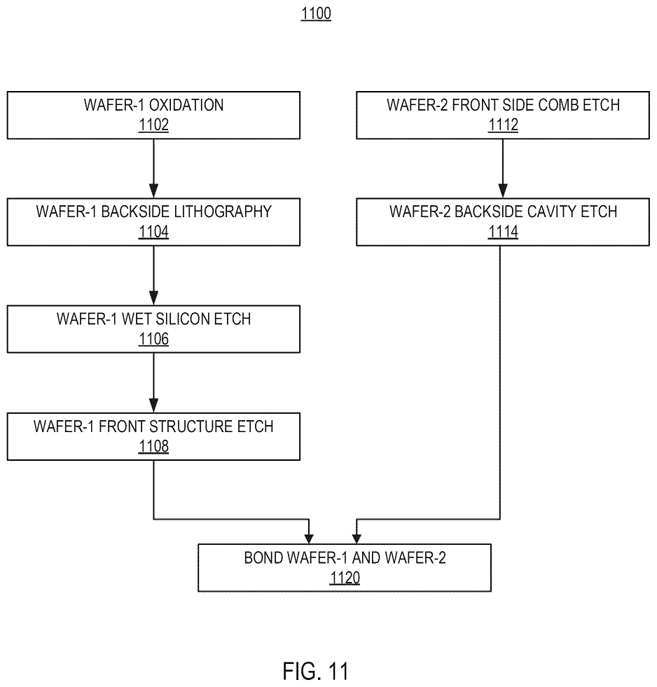

FIG. 11 illustrates a flow diagram for a method of fabricating a micro rotary scanning grating device, according to some examples. The method 1100 is provided by way of example, as there may be a variety of ways to carry out the method described herein. The method 1100 may be executed or otherwise performed by one or more processing components of another system or a combination of systems. Each block shown in FIG. 11 may further represent one or more processes, methods, or subroutines, and one or more of the blocks (e.g., the selection process) may include machine readable instructions stored on a non-transitory computer readable medium and executed by a processor or other type of processing circuit to perform one or more operations described herein.

At block 1102, a first wafer may be oxidized to form the grating structure (front structure) and subjected to backside lithography for subsequent etching underneath the front structure at block 1104. At block 1106, a portion of the silicon substrate underneath the grating structure may be removed through a wet silicon etch or similar process. Subsequently, at block 1108, the front structure (grating structure) may be etched depending on the type and dimensions of the gratings.

In a parallel process, a second wafer may be oxidized and etched to form the comb drive actuator at block 1112. At block 1114, a portion of the silicon substrate underneath the comb structure may be removed through etching, leaving a cavity underneath the comb drive actuator.

The first and second wafers may then be bonded together at block 1120 such that the grating structure is positioned on top of the comb drive actuator. The cavities underneath the grating structure and the comb drive structure allow light to pass through before being diffracted by the grating structure, and the comb drive structure allows the grating structure to be rotated.

The fabrication process of the method 1100 is an example process for illustration purposes. The micro rotary scanning grating device as described herein may be fabricated using fewer or additional steps. Additional fabrication steps such as spin-coating, photo-alignment, passivation, etc. may also be used.

According to examples, a method of making a micro rotary scanning grating device is described herein. A system of making the micro rotary scanning grating device is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A method to fabricate a micro rotary scanning device comprising:
oxidizing a first wafer to form a grating structure;
removing a portion of a silicon substrate of the first wafer underneath the grating structure through wet silicon etching;
oxidizing a second wafer;
forming a comb drive structure through etching; and
removing a portion of a silicon substrate of the second wafer underneath the comb drive structure through wet silicon etching.

2. The method of claim 1, further comprising applying backside lithography to the first wafer prior to removing the portion of the silicon substrate.

3. The method of claim 1, further comprising bonding the first wafer and the second wafer together.

4. The method of claim 3, wherein bonding the first wafer and the second wafer together comprises aligning the grating structure and the comb drive structure such that a first cavity underneath the grating structure and a second cavity underneath the comb drive structure are aligned for light transmission.

5. The method of claim 3, wherein the bonded first wafer and second wafer have a polygonal shape.

6. The method of claim 1, wherein the forming the grating structure includes front side etching.

7. The method of claim 1, further comprising removing a portion of a silicon substrate underneath the comb drive structure to leave a cavity.

8. A micro rotary scanning element for an augmented reality / virtual reality (AR/VR) display device, the micro rotary scanning element, comprising:
a transmissive grating structure; and
an angular comb drive structure, wherein
the transmissive grating structure is to diffract received collimated light and is anchored to the angular comb drive structure, and
the angular comb drive structure comprises a plurality of inter-positioned comb elements to provide angular rotation to the transmissive grating structure.

9. The micro rotary scanning element of claim 8, wherein the transmissive grating structure and the angular comb drive structure are formed on two respective wafers bonded together.

10. The micro rotary scanning element of claim 8, wherein the angular comb drive structure is also transmissive.

11. The micro rotary scanning element of claim 8, wherein the transmissive grating structure is formed via oxidizing a first wafer.

12. The micro rotary scanning element of claim 11, wherein the first wafer is further subjected to backside lithography for etching.

13. The micro rotary scanning element of claim 8, wherein the angular comb drive structure is formed via oxidizing and etching of a second wafer.

14. A non-transitory computer readable medium configured to store program code instructions, when executed by a processor, cause the processor to perform steps comprising:
oxidize a first wafer to form a grating structure;
remove a portion of a silicon substrate of the first wafer underneath the grating structure through wet silicon etching;
oxidize a second wafer;
form a comb drive structure through etching; and
remove a portion of a silicon substrate of the second wafer underneath the comb drive structure through wet silicon etching.

15. The non-transitory computer readable medium of claim 14, wherein the instructions, when executed by the processor, cause the processor to apply backside lithography to the first wafer prior to removing the portion of the silicon substrate.

16. The non-transitory computer readable medium of claim 14, wherein the instructions, when executed by the processor, cause the processor to bond the first wafer and the second wafer together.

17. The non-transitory computer readable medium of claim 16, wherein the bonded first wafer and second wafer have a polygonal shape.

18. The non-transitory computer readable medium of claim 14, wherein bonding the first wafer and the second wafer together comprises aligning the grating structure and the comb drive structure such that a first cavity underneath the grating structure and a second cavity underneath the comb drive structure are aligned for light transmission.

19. The non-transitory computer readable medium of claim 14, wherein to form the grating structure, the instructions, when executed by the processor, cause the processor to implement front side etching.

20. The non-transitory computer readable medium of claim 14, wherein the instructions, when executed by the processor, cause the processor to remove a portion of a silicon substrate underneath the comb drive structure to leave a cavity.
